(19) United States
(12) Patent Application Publication
(10) Pub. No.: US 2026/0250139 A1
(43) Pub. Date: Aug. 27, 2026

(54) Producing Commercially Pure Carbon Dioxide From Rubblized Carbon Based Ore

(71) Applicant: Red Leaf Resources, Inc., Salt Lake City, UT (US)

(72) Inventor: James PATTEN, Salt Lake City, UT (US)

(21) Appl. No.: 18/875,892

(22) PCT Filed: Jun. 23, 2023
(86) PCT No.: PCT/US2023/068951

§ 371 Date: Dec. 17, 2024

Related U.S. Application Data
(60) Provisional application No. 63/354,901, filed on Jun. 23, 2022.

(51) Int. Cl. C01B 32/50; B01D 53/00; C10B 57/14

(52) U.S. Cl. CPC C01B 32/50; B01D 53/002; C10B 57/14; B01D 2256/22; B01D 2257/702

(57) ABSTRACT

A method (100) of producing commercially pure carbon dioxide can include providing (110) a body of rubblized carbon based ore. The body of rubblized carbon based ore can be heated (120) at an elevated temperature under an oxygen deficient atmosphere to produce water, carbon dioxide, a residual mineral ore, and optionally hydrocarbon products. The carbon dioxide can be separated (130) from the water and optional hydrocarbon products. The carbon based ore can include oil shale, coal, tar sands, peat, tasmanite, or a combination thereof.

### RELATED APPLICATION

This application claims priority to U.S. Application No. 63/354,901, filed Jun. 23, 2022 which is incorporated herein by reference.

### BACKGROUND

Carbon dioxide is used for a variety of applications in the food industry, oil industry, chemical industry, and in other areas. For example, carbon dioxide is used as a food additive and in carbonated beverages. Carbon dioxide can also be used in agriculture, such as for increasing the carbon dioxide content of the atmosphere inside greenhouses. Solid and liquid carbon dioxide are used as refrigerants for food and other purposes. In the oil industry, carbon dioxide can be used for enhanced oil recovery, which involves injecting carbon dioxide into oil reservoirs to increase the amount of oil recovered. Supercritical carbon dioxide can also be used as a solvent in various chemical applications. Accordingly, carbon dioxide of sufficient purity can be a valuable product.

### SUMMARY

The present disclosure describes methods of producing commercially pure carbon dioxide from carbon based ores such as oil shale, coal, tar sands, peat, tazmanite, or others. In some examples, a method of producing commercially pure carbon dioxide can include providing a body of rubblized carbon based ore. The body of rubblized carbon based ore can be heated at an elevated temperature under an oxygen deficient atmosphere to produce water, carbon dioxide, a residual mineral ore, and optionally hydrocarbon products. The carbon dioxide can then be separated from the water and optional hydrocarbon products.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flow diagram showing a method of producing commercially pure carbon dioxide in accordance with one example.

FIG. 2 is a schematic illustration of a system for producing commercially pure carbon dioxide in accordance with one example.

FIG. 3 is a schematic illustration of another system for producing commercially pure carbon dioxide in accordance with another example.

FIG. 4 is a schematic illustration of another system for producing commercially pure carbon dioxide in accordance with another example.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a vessel” includes reference to one or more of such systems and reference to “the inlet” refers to one or more of such devices.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

As used herein, whenever any property is referred to that can have a distribution between differing values, such as a temperature distribution, particle size distribution, etc., the property being referred to represents an average of the distribution unless otherwise specified. Therefore, “particle size of the carbon based ore” refers to an average particle size, and “temperature of the body of carbon based ore” refers to an average temperature of the body of ore. Average particle sizes can refer to number-average particle sizes. Average temperatures can refer to volumetric-average temperatures.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Methods of Producing Commercially Pure Carbon Dioxide

As mentioned above, carbon dioxide has many uses in a variety of industries. The present disclosure describes methods of producing carbon dioxide through heating a rubblized carbon based ore. As used herein, “carbon based ore” can include a variety of carbonaceous materials such as oil shale, coal, tar sands, peat, tazmanite, or others. In some cases, the carbon dioxide can be the main product of this process. However, in other examples, the methods described herein can be performed as part of a process that produces multiple products such as liquid hydrocarbons, gaseous hydrocarbons, valuable minerals, water, energy, or other products. The carbon dioxide can be a secondary product in such examples. The methods described herein can also provide beneficial uses for the carbon dioxide as an alternative to simply disposing of the carbon dioxide by exhausting it to the atmosphere.

In some examples, the methods described herein can produce commercially pure carbon dioxide. This can include different levels of purity depending on the application for which the carbon dioxide will be used. In various examples, the carbon dioxide can have a purity of 95% or greater, 98% or greater, 99% or greater, 99.5% or greater, or 99.9% or greater by volume. The impurities in the carbon dioxide gas can mainly include hydrocarbons in some examples.

Producing commercially pure carbon dioxide gas is often not feasible if the source has a very low carbon dioxide concentration. For example, air typically includes carbon dioxide in a concentration of about 0.04% by volume. Purifying the carbon dioxide directly from air would be much too expensive to be feasible. Ordinary combustion processes such as burners, engines, and so on also often produce a concentration of carbon dioxide that is too low for cost-effective carbon dioxide purification.

Accordingly, the methods described herein can produce a stream of gas that has a comparatively higher concentration of carbon dioxide, with a smaller amount of other gases present, so that purifying the carbon dioxide can be accomplished at a lower cost. Some specific examples can include using an oxygen deficient atmosphere for heating the rubblized carbon based ore, using a nitrogen-free atmosphere, and converting carbonate minerals in the carbon based ore to carbon dioxide. In certain examples, the methods described herein can include recovering an effluent fluid stream from the heated carbon based ore, before separating the carbon dioxide, where the effluent fluid stream has a carbon dioxide concentration from about 5% by volume to about 50% by volume. This effluent fluid stream can also be devoid of nitrogen or substantially devoid of nitrogen in some examples. In some particular examples the effluent fluid stream can consist essentially of carbon dioxide, hydrocarbons, and water vapor. For example, the effluent fluid can be made up of at least 98% or at least 99%, by volume, of carbon dioxide, hydrocarbons, and water vapor. Thus, the methods described herein can provide an effluent stream from which carbon dioxide can be easily separated.

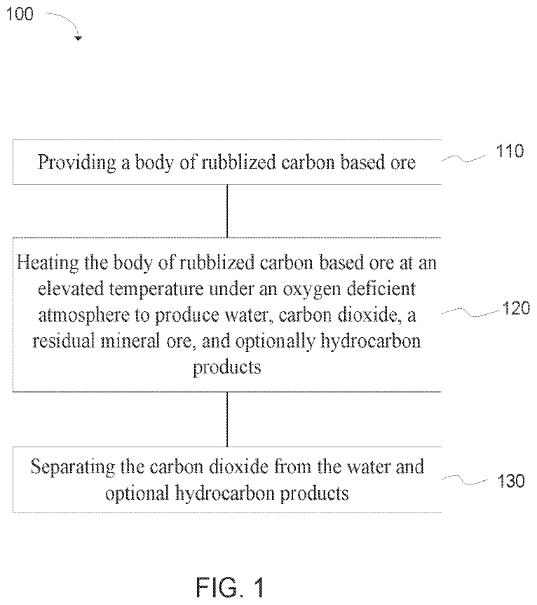

With this description in mind, FIG. 1 is a flowchart illustrating one example method of producing commercially pure carbon dioxide 100. The method includes: providing a body of rubblized carbon based ore 110; heating the body of rubblized carbon based ore at an elevated temperature under an oxygen deficient atmosphere to produce water, carbon dioxide, a residual mineral ore, and optionally hydrocarbon products 120; and separating the carbon dioxide from the water and optional hydrocarbon products 130.

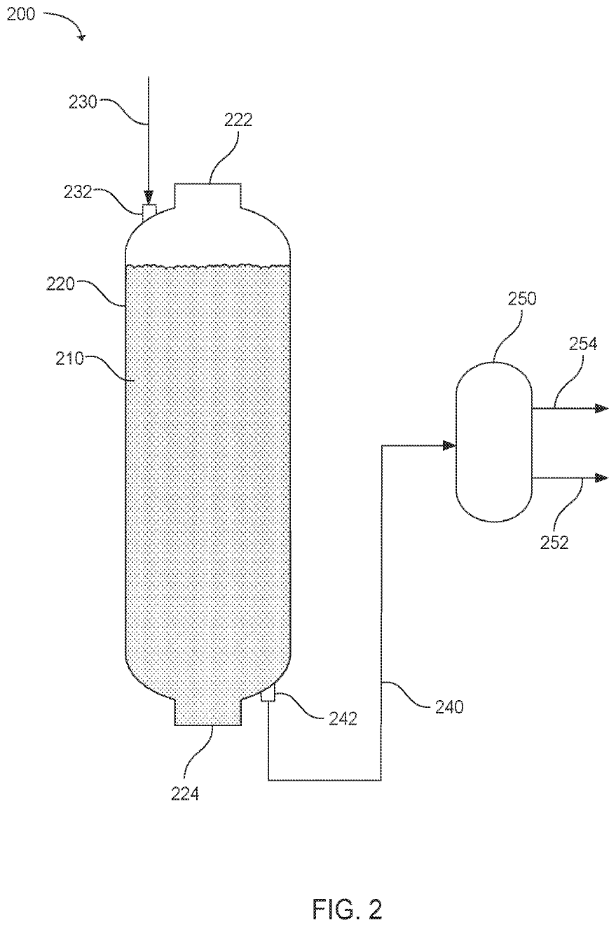

FIG. 2 is a schematic illustration of an example system 200 that can be used to perform a method of producing commercially pure carbon dioxide as described herein. The system includes a body of rubblized carbon based ore 210. The body of rubblized carbon based ore is held inside a vessel 220. The rubblized carbon based ore can be introduced into the vessel through an ore inlet 222. Residual mineral ore can be removed from the vessel through an ore outlet 224. A heating fluid stream 230 enters the vessel through a fluid inlet 232. An effluent fluid stream 240 flows out of the vessel through a fluid outlet 242. The effluent stream flows to a separator 250 that separates carbon dioxide from other components of the effluent stream. In this example, a carbon dioxide stream 252 and a residual stream 254 flow out of the separator.

The body of rubblized carbon based ore can be contained inside a vessel such as the vessel shown in FIG. 2. The vessel can be a retort such as a vertical retort, a horizontal retort, an inclined retort, etc. The vessel can have walls formed of suitable materials such as steel, other metals, cement, ceramic, fire bricks, or others. In some examples, the vessel walls can be insulated or without insulation. The size and shape of the vessel is not particularly limited. In some examples, the vessel can be a vertical vessel having a height from about 10 meters to about 100 meters and a width from about 3 meters to about 30 meters. In certain examples, the height can be from about 30 meters to about 100 meters, or from about 50 meters to about 100 meters, or from about 10 meters to about 30 meters. In further examples, the width can be from about 10 meters to about 30 meters, or from about 20 meters to about 30 meters, or from about 3 meters to about 10 meters. If the vessel is an inclined vessel, the vessel can have similar dimensions to the vertical vessels described above, but turned on an incline. If the vessel is a horizontal vessel, the vessel can have similar dimensions to the vertical vessels described above, but turned horizontal.

Although the example shown in FIG. 2 includes a vessel to contain the body of carbon based ore, in other examples the carbon based ore may not be contained in a vessel. In certain examples, the methods described herein can be applied to an in-capsule system, similar to the systems described in U.S. Pat. No. 7,862,705, which is incorporated herein by reference. In these examples, the body of crushed carbon based ore can be formed inside an impoundment that prevents uncontrolled migration of gases and liquids into and out of the impoundment. The impoundment can include walls having multiple layers comprising particulate earthen materials such as swelling clay, gravel, spent carbon based ore, and others. In some cases, the size of the impoundment can be relatively large. As an illustration, single impoundments can range in size from 15 meters across to 200 meters, and often from about 100 to 160 meters across. Optimal impoundment sizes may vary, but suitable impoundment areas can often range from about one-half to ten acres in top plan surface area. Additionally, the impoundment can have a depth from about 10 meters to about 50 meters.

As mentioned above, in some examples the body of carbon based ore can be contained in a vessel having an ore inlet and an ore outlet. Carbon based ore can be loaded through the ore inlet and then heated as a batch before removing the ore through the ore outlet. In such examples, the carbon based ore can be substantially stationary during heating. In other examples, the process can be operated continuously and carbon based ore can be continuously fed into the vessel at the ore inlet and removed from the vessel at the ore outlet. The carbon based ore can be heated for a heating time from about 0.1 hour to about 24 hours, or from about 0.5 hour to about 20 hours, or from about 1 hour to about 12 hours, or from about 8 hours to about 24 hours. These times can be the time for heating a batch of ore in a batch process, or the residence time of ore moving through the vessel in a continuous process.

Although some examples described herein focus on processing oil shale, the systems and methods described herein can also be used to process other types of carbon based ore. The carbon based ore can be a hydrocarbon-containing material from which hydrocarbon products can be extracted or derived. For example, hydrocarbons may be extracted directly as a liquid, removed via solvent extraction, directly vaporized, by conversion from a feedstock material, or otherwise removed from the material. Many carbon based ores contain kerogen or bitumen which is converted to a flowable or recoverable hydrocarbon through heating and pyrolysis. Carbon based ores can include, but are not limited to, oil shale, tar sands, coal, peat, tazmanite, and other organic rich rock. In certain examples, the carbon based ore can be Green River oil shale from the Mahogany marker. Existing hydrocarbon-containing materials in the carbon based ore can be upgraded and/or released from the carbon based ore through a chemical conversion into more useful hydrocarbon products. Chemical conversion can include synthesis reactions, decomposition reactions or other reactions which result in chemically distinct product compounds. Such chemical conversions can be accomplished thermally, catalytically, and/or via addition of other chemical components.

Some carbon based ores can also include carbonate minerals. Carbonates in the carbon based ore can include calcite, dolomite, siderite, nahcolite, dawsonite, ankerite, barium carbonate, and others. The amount of carbonate minerals in the carbon based ore can vary depending on the type of carbon based ore. In some examples, the carbon based ore can include carbonate minerals in an amount from about 1 wt % to about 80 wt %. Some carbonate minerals can decompose thermally to form carbon dioxide when heated at a sufficient temperature. The decomposition temperature for some carbonate minerals can be from about 950° F. to about 1500° F. Thus, decomposition of carbonate minerals can increase the total amount of carbon dioxide obtained from the process.

In some examples, the body of rubblized carbon based ore used in the methods described herein can be a body of raw carbon based ore. As used herein, “raw carbon based ore” refers to carbon based ore that has not been processed to remove any hydrocarbon content from the ore, such as oil shale that has not undergone a pyrolysis process to convert kerogen in the oil shale to hydrocarbon products.

As mentioned above, the methods of producing carbon dioxide can sometimes also produce hydrocarbon products. Accordingly, in some cases the methods can involve a pyrolysis process that occurs simultaneously with generating carbon dioxide. Raw carbon based ore can be heated under an oxygen deficient atmosphere to produce water, carbon dioxide, a residual mineral ore, and hydrocarbon products through pyrolysis of hydrocarbon contents in the carbon based ore. The carbon dioxide can be formed by a combustion reaction between oxygen and hydrocarbons or other organic content if oxygen is present in the atmosphere. If no oxygen is present in the atmosphere, carbon dioxide can still be produced through thermal decomposition of carbonate minerals in the carbon based ore. In some examples, carbon dioxide can be produced in both of these ways simultaneously. In particular, a limited amount of oxygen can be introduced into the body of rubblized carbon based ore so that combustion occurs within the body of rubblized carbon based ore, and carbonate minerals in the ore can also decompose to form carbon dioxide. The heat generated by the combustion reaction can drive the decomposition of carbonate minerals and also the pyrolysis of organic contents in the ore. The concentration of oxygen in the body of rubblized carbon based ore can be kept at a less-then-stoichiometric level, meaning that the amount of oxygen present is not sufficient to burn all of the hydrocarbons and other combustible organic content present. By using a sub-stoichiometric amount of oxygen, the temperature of the body of rubblized carbon based ore can be controlled and kept at a relatively low temperature. In some examples, the rubblized carbon based ore can be heated to an elevated temperature from 600° F. to 950° F. This elevated temperature can be lower than the temperature that would be reached if a stoichiometric amount of oxygen were used. In further examples, raw carbon based ore can be heated at an elevated temperature from 600° F. to 900° F., or 600° F. to 800° F., or 600° F. to 700° F., or 700° F. to 950° F., or 800° F. to 950° F.

The rubblized carbon based ore used in the methods described herein may include spent carbon based ore. As used herein, “spent carbon based ore” and “spent oil shale” refer to materials that have already been used to produce hydrocarbons. Typically after producing hydrocarbons from a carbon based ore, the remaining material is mostly mineral with the organic content largely removed. In some cases, spent oil shale can have a sufficient amount of residual hydrocarbon or carbon content that the spent oil shale can be burned to generate additional heat and carbon dioxide. Additionally, spent carbon based ore can include carbonate minerals that can decompose to form additional carbon dioxide.

In certain examples, spent carbon based ore can be obtained through a low-temperature pyrolysis process such as the oxygen-limited pyrolysis process described above. However, a low-temperature pyrolysis process that is performed in an oxygen-free atmosphere can also be used. The temperature of the pyrolysis process can be from 600° F. to 950° F., or 600° F. to 900° F., or 600° F. to 800° F., or 600° F. to 700° F., or 700° F. to 950° F., or 800° F. to 950° F., in some examples. This pyrolysis process can produce hydrocarbon products and the spent carbon based ore from which the hydrocarbon products have been removed. This spent ore can then be used to generate carbon dioxide by heating to an elevated decomposition to decompose carbonate minerals in the spent ore. Some carbonate minerals can have a higher decomposition temperature than the pyrolysis temperature that was used during the low-temperature pyrolysis process. Therefore, the spent ore can be heated to a higher temperature after the hydrocarbon products have been removed by pyrolysis. In certain examples, the spent ore can be heated to a decomposition temperature from 950° F. to 1500° F. to decompose carbonate minerals in the spent ore. In further examples, the spent ore can be heated to a temperature from 1000° F. to 1500° F., or from 1100° F. to 1500° F., or from 1200° F. to 1500° F., or from 1300° F. to 1500° F., or from 1400° F. to 1500° F., or from 1000° F. to 1100° F., or from 1000° F. to 1200° F., or from 1000° F. to 1300° F., or from 1000° F. to 1400° F.

In some examples, the body of rubblized carbon based ore can be formed from particulate carbon based ore that is sized to obtain a desired target void space. The body of carbon based ore can have greater than about 10% void space, or can have void space from about 20% to 50%, although other ranges may be suitable such as up to about 70%. High void space can allow for high permeability of the body of carbon based ore. Allowing for high permeability facilitates heating of the body through convection as the primary heat transfer mechanism while also substantially reducing costs associated with crushing to very small sizes, e.g. below about 2.5 to about 1 cm. Specific target void space can vary depending on the particular carbon based ore and desired process times or conditions. Particle sizes throughout the body of carbon based ore can vary depending on the material type, desired heating rates, and other factors. In some examples, the body of rubblized carbon based ore can include particles up to about 2 meters in size, or less than 30 cm, or less than about 16 cm. In certain examples, the maximum particle size of the carbon based ore can range from about 5 cm to about 60 cm, or about 16 cm to about 60 cm, or from about 1 cm to about 5 cm. In further examples, the average particle size of the rubblized carbon based ore can be from about 1 mm to about 60 cm, or from about 5 mm to about 30 cm, or from about 5 mm to about 10 cm, or from about 5 mm to about 5 cm. Optionally, the body of rubblized carbon based ore can include bi-modal or multi-modal size distributions in order to provide increased balance of void space and exposed particulate surface area. The void space and exposed particulate surface can be useful for allowing heating fluid to pass through the ore and contact ore particles and also for removing materials from the ore particles such as hydrocarbon products and carbon dioxide produced by decomposing carbonate minerals in the ore.

The rubblized carbon based ore being heated can maintain a sufficient porosity to allow gas transport through the body of rubblized carbon based ore throughout the heating process. In particular, the rubblized carbon based ore can maintain a sufficient porosity to allow gas transport of the gaseous and vapor hydrocarbon products that are produced during pyrolysis, and carbon dioxide gas that is produced during heating. Some types of carbon based ore can have inherent porosity. Mineral materials such as oil shale can include a rigid mineral structure that has porosity including pores that are internal in individual particles of the material, or void spaces between rigid particles of the material, or a combination thereof. Other types of carbon based ore may not have inherent porosity. In certain examples, the carbon based ore can be mixed with a rigid mineral material such as oil shale. The mineral structure of the oil shale can survive the pyrolysis process and the mineral structure can maintain the porosity of the body of carbon based ore. Any other carbon ore materials that may not have sufficient porosity can likewise be mixed with a secondary carbon ore material that has a mineral structure that can survive the pyrolysis process. Thus, the combined body of carbon ore can maintain sufficient porosity to allow gas transport of gas and vapor hydrocarbon products during pyrolysis.

Raw oil shale can be obtained and rubblized to a desired particle distribution and size. Kerogen content in raw oil shale can vary depending on the particular formation source from which it is mined. Similarly, mineral content and other composition variables can vary considerably among different raw oil shales. However, as a very general guideline, the initial kerogen content is greater than 5% by weight. In some cases the initial kerogen content can be greater than 50% such as when treating raw oil shale. Alternatively, the methods described herein can be applied to hydrocarbonaceous products having a lower initial kerogen content such as from 5% to 50% by weight, and in some cases 5% to about 35% by weight.

As mentioned above, the body of rubblized carbon based ore can be heated under an oxygen deficient atmosphere. A working fluid can be passed through the body of rubblized carbon based ore to facilitate heating of the ore. In some examples, the working fluid can include oxygen in a sub-stoichiometric amount and the oxygen can support combustion within the body of rubblized carbon based ore. The combustion can provide at least some of the heat for heating the ore in such examples. In certain examples, the working fluid can be introduced at a low temperature such as around room temperature or ambient temperature, and then combustion in within the body of rubblized carbon based ore can provide a sufficient amount of heat to heat the ore up to the elevated processing temperature. The working fluid can also be preheated before the working fluid is injected into the body of rubblized carbon based ore. Some heat can be contributed by this preheating and the remaining heat can be produced by combustion within the body of rubblized carbon based ore. In alternative examples, the working fluid can be free of oxygen and all of the heat used to heat the ore can be introduced by preheating the working fluid.

The working fluid can include hydrocarbon gases, hydrocarbon vapors, steam, hot air, oxygen, and other fluids in a variety of mixtures or ratios. In some examples, the oxygen concentration in the working fluid can be less than about 21% by volume. In other examples, the oxygen concentration can be less than 10% by volume, or less than 5% by volume. In certain examples, the working fluid can consist essentially of hydrocarbon gas and oxygen in one of these concentrations. The oxygen can be in the form of air, oxygen-enriched air, pure oxygen, or another mixture including oxygen. In certain examples, pure oxygen can be provided from an oxygen tank. In other examples, pure oxygen, nearly pure oxygen, or oxygen-enriched air can be provided by a pressure swing oxygen generator or oxygen concentrator.

The working fluid can be injected into the body of rubblized carbon based ore as a single fluid stream or as multiple fluid streams that mix together after injection. For example, the rubblized carbon based ore can be contained in a vessel and the working fluid can be injected into the vessel. In a certain example, a working fluid that includes hydrocarbon gas and oxygen can be injected into the vessel as a single gas stream. However, in an alternative example, oxygen can be injected in a separate stream from the hydrocarbon gas. Injecting oxygen as a separate stream can be useful because the concentration of oxygen in the vessel can be adjusted by changing the flow rate of the oxygen stream into the vessel. The concentration of oxygen can be related to the temperature in the vessel, since a higher oxygen concentration can support combustion at a higher temperature in the vessel. Thus, a process control system can be used to control the temperature in the vessel by adjusting the flow rate of oxygen into the vessel. In certain examples, an oxygen stream and a hydrocarbon stream can be injected into a headspace in the vessel above the rubblized carbon based ore. The oxygen and hydrocarbon gas can mix in the headspace and within the rubblized carbon based ore as the gases pass through the vessel. The oxygen stream can be pure oxygen in some examples, while in other examples the oxygen stream can include oxygen mixed with an inert gas such as nitrogen, argon, or other gas. The oxygen stream may also be a mixture of oxygen and a hydrocarbon gas, and a secondary hydrocarbon stream can also be injected. This can allow the concentration of oxygen to be adjusted by adjusting the flow rates of the oxygen stream and/or the secondary hydrocarbon stream. In certain examples, the hydrocarbon stream or secondary hydrocarbon stream can be a recycle stream that recycles hydrocarbons collected from the body of rubblized carbon based ore.

In other examples, the concentration of oxygen in the working fluid can be varied by pre-mixing a desired amount of oxygen with other components of the working fluid and then injecting the mixture into the body of rubblized carbon based ore. For example, oxygen can be premixed with a hydrocarbon gas stream. The amount of oxygen added to the hydrocarbon gas stream can be selected to provide a specific oxygen concentration. The mixture of oxygen and hydrocarbon gas can then be injected into the body of rubblized carbon based ore or vessel containing the ore. This can allow the oxygen concentration of the working fluid stream to be controlled. In some examples, the hydrocarbon stream can be a recycle stream as mentioned above.

When the working fluid includes oxygen, the working fluid can be injected at a temperature that is less than an autoignition temperature of the working fluid. In some examples, a combustion region or combustion front can be present at a location in the body of rubblized carbon base ore. The ore in this region can be at or above the autoignition temperature of the working fluid. When the working fluid contacts this region the working fluid can ignite, causing a combustion reaction of the oxygen and hydrocarbons. It is noted that the working fluid can include hydrocarbons in some examples, while in other examples the working may not include hydrocarbons but the carbon based ore can contain hydrocarbons or other combustible material that can participate in the combustion reaction with oxygen. Thus, the oxygen in the working fluid can support the combustion within the body of rubblized carbon based ore and the combustion can provide heat to continue heating the carbon based ore. In further examples, igniters can be used to ignite the working fluid. For example, the working fluid can be injected into the vessel at a temperature below the autoignition temperature of the working fluid, and then igniters located inside the vessel can be used to ignite the working fluid to initiate the combustion reaction.

Although the working fluid can include a variety of different gases in combination, in some examples it can be useful to minimize the number of components in order to make it easier to separate out the carbon dioxide that is generated in the body of rubblized carbon based ore. In some examples, the working fluid can consist or consist essentially of oxygen and hydrocarbon gas. The hydrocarbon gas can include one or multiple light hydrocarbons, such as methane, ethane, and propane. In certain examples, oxygen and hydrocarbon gas can make up at least 95% by volume of the working fluid, or at least 98% by volume, or at least 99% by volume of the working fluid. The oxygen can be substantially all consumed by combustion reactions within the body of rubblized carbon based ore. Therefore, the effluent stream from the body of rubblized carbon based ore can include little or no oxygen. The effluent stream can be primarily made up of or consist essentially of carbon dioxide, water vapor, and hydrocarbons. The hydrocarbons can include hydrocarbon gas that was injected as working fluid, which remains uncombusted, and/or hydrocarbons that were derived from heating the carbon based ore. In some examples, the effluent stream can be at least 95% by volume, or at least 98% by volume, or at least 99% by volume made up of carbon dioxide, water vapor, and hydrocarbons. The carbon dioxide can then be separated from the hydrocarbons and water.

In certain examples, the working fluid can be free of nitrogen gas or substantially free of nitrogen gas, so that the effluent can also be free or substantially free of nitrogen gas. This can be useful because using a nitrogen-free atmosphere eliminates the need for separating carbon dioxide from nitrogen. This can make the purification of the carbon dioxide easier and more cost-effective. Using nitrogen-free working fluid also eliminates the need for venting excess nitrogen. As mentioned above, the method can include recycling the gases separated from carbon dioxide back to the body of rubblized carbon based ore. The recycle gas can include hydrocarbons, which can be used as a fuel for combustion and as a heat carrier fluid. However, if nitrogen is introduced in the working fluid, such as by using air to supply oxygen, then nitrogen would accumulate in the process unless excess nitrogen is vented to the atmosphere. Such venting would waste heat energy that could otherwise be used in the heating process. Additionally, if the recycle stream includes both nitrogen and hydrocarbons then some hydrocarbons would be vented to the atmosphere as well. The hydrocarbons could otherwise be used as fuel in the heating process.

In some examples, the working fluid can be injected into the vessel at a temperature from 0° F. to 600° F., or from 100° F. to 600° F., or from 200° F. to 600° F., or from 300° F. to 500° F., or from 100° F. to 300° F. If multiple different streams are injected into the vessel, then the average temperature of these streams when mixed together can be within these ranges. As mentioned above, the working fluid can include oxygen and hydrocarbon gas, and the initial temperature of the working fluid can be below the autoignition temperature of the working fluid. In further examples, the working fluid can be free of oxygen and the injection temperature can be from 600° F. to 950° F., or from 600° F. to 900° F., or from 600° F. to 800° F., or from 600° F. to 700° F., or from 700° F. to 950° F., or from 800° F. to 950° F. In still further examples, the working fluid can be free of oxygen and the injection temperature can be from 1000° F. to 1500° F., or from 1100° F. to 1500° F., or from 1200° F. to 1500° F., or from 1300° F. to 1500° F., or from 1400° F. to 1500° F., or from 1000° F. to 1100° F., or from 1000° F. to 1200° F., or from 1000° F. to 1300° F., or from 1000° F. to 1400° F.

The flow rate of working fluid into the body of rubblized carbon based ore can vary depending on the volume of the body of carbon based ore. In some examples, the flow rate of working fluid into the body of rubblized carbon based ore can be sufficient to replace the volume of gas in the body of rubblized carbon based ore from about once per minute to about once per day. The volume of gas in the body can correspond to the void space volume in the body of rubblized carbon based ore. In further examples, the flow rate of working fluid can be sufficient to replace the volume of gas in the body of rubblized carbon based ore from about once per ten minutes to about once per day, or from about once per hour to about once per day, or from about once per minute to about once per hour.

During processing temperature profiles throughout the body of rubblized carbon based ore can provide valuable feedback for controlling operation of the process. Accordingly, in one example, the method can include actively monitoring an outlet temperature and/or a combustion temperature in order to dynamically adjust at least one of the inlet mass flow rate, the inlet temperature, and the inlet oxygen concentration. As a specific example, the actively monitoring can include use of at least one temperature sensor associated with an internal surface of the vessel or the rubblized carbon based ore bed.

Although pressures can vary somewhat, most often the body of rubblized carbon based ore can be maintained at a pressure from about 0.8 atm to about 2 atm during the heating process.

Some carbon based ores can release liquid hydrocarbons when heated. These liquid hydrocarbons can drain through the bed of carbon based ore to the bottom of the vessel. In some examples, a liquid outlet can be located at or near the bottom of the vessel. In certain examples, the liquid outlet and the effluent outlet can be a single outlet. In other examples, an effluent outlet can be used to remove gas and vapor components, such as the carbon dioxide, water vapor, and non-condensed hydrocarbons liberated from the oil shale. A liquid outlet that is separate from the effluent outlet can be used to remove liquid hydrocarbon products from the vessel.

The carbon dioxide produced in the body of rubblized carbon based ore can be separated from other components of the effluent stream using one or more suitable separators. In some examples, the effluent stream can include water vapor and condensable hydrocarbons. As a first stage of separation, the water and condensable hydrocarbons can be condensed to form liquid water and liquid hydrocarbons. These can be easily separated from the gaseous components of the effluent stream. The carbon dioxide can then be separated from the non-condensable hydrocarbons. The non-condensable hydrocarbons can then be recycled as a heat carrier gas and fuel gas for use in heating the body of rubblized carbon based ore.

Some examples of separators that can be used to separate carbon dioxide from non-condensed hydrocarbons can include cryogenic distillation separators, membrane separators, sorbent separators, and solvent separators. Solvent separators can employ solvents to scrub carbon dioxide from the hydrocarbon gas of the effluent stream. The carbon dioxide can subsequently be separated from the solvent to regenerate the solvent. In some examples, solvents can include amine compounds such as monoethanolamine. Sorbent separators can include a solid sorbent material such as a zeolite or activated carbon. Some sorbent separators use pressure swing adsorption or temperature swing adsorption. Membrane separators include a gas separation membrane that can allow some gases to pass through faster than others. Some membrane materials include porous inorganic membranes, palladium membranes, polymeric membranes, and zeolites. Cryogenic separation involves cooling the effluent stream condense some components of the stream. Carbon dioxide can be condensed at a sufficiently high pressure and low temperature.

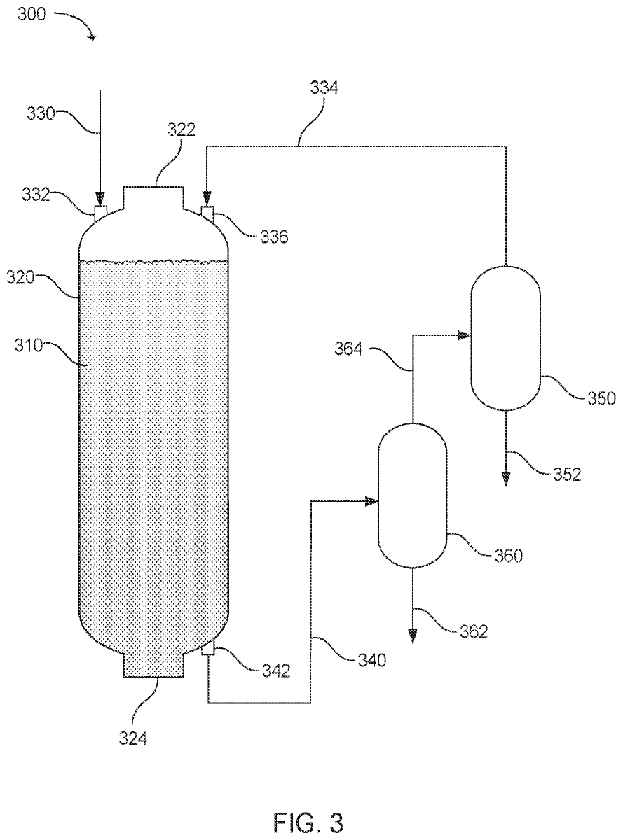

FIG. 3 shows another example system 300 that can be used to perform a method of producing commercially pure carbon dioxide in accordance with the present disclosure. This system includes a body of rubblized carbon based ore 310 held inside a vessel 320. This vessel includes an ore inlet 322 and an ore outlet 324. In this example, an oxygen-containing stream 330 flows into the vessel through an oxygen inlet 332. This oxygen-containing stream can be pure oxygen or oxygen mixed with other gases. The system also includes a recycle stream 334 that flows into the vessel through a recycle inlet 336. In this example, the recycle stream can include non-condensed hydrocarbons. In some cases, the concentration of oxygen in the vessel can be controlled by controlling the flow rates of the oxygen-containing stream and the recycle stream into the vessel. This system also includes an effluent fluid stream 340 flowing out through a fluid outlet 342. The effluent stream flows to a gas-liquid separator 360 that can be configured to condense water and condensable hydrocarbons in the effluent stream. The water and condensed hydrocarbons can then flow out as a liquid stream 362. A gas stream 364 can flow from the gas-liquid separator to a carbon dioxide separator 350. This separator can separate carbon dioxide from other components of the gas stream. The carbon dioxide can flow out as a carbon dioxide stream 352 and the remaining components can be recycled as the recycle stream back to the vessel of carbon based ore.

After the carbon dioxide has been produced and separated, the carbon dioxide can be used for a variety of purposes. In some examples, the carbon dioxide can be injected into an oil well as part of an enhanced oil recovery process. Enhanced oil recovery can be used to extract a larger amount of oil from oil fields than primary oil recovery alone. In certain examples, an enhanced oil recovery process can include injecting water into an oil reservoir to force a portion of flowable hydrocarbons out of the oil reservoir to be produced at the surface. Carbon dioxide can then be injected into the oil reservoir to further produce hydrocarbons from the reservoir. The water and/or carbon dioxide can be injected into the oil reservoir after a portion of the oil originally present in the reservoir has already been produced through primary oil recovery. The use of carbon dioxide injection with or without water injection can increase the amount of oil recovered from the reservoir compared to producing oil without these enhanced recovery stages. In some examples, the total amount of oil produced can be from 150% to 300% of the amount that would be produced without the injection of carbon dioxide or water. The carbon dioxide can be compressed to a supercritical state in some examples.

The methods described herein can be performed at or near the site of an oil well where the carbon dioxide is to be used for enhanced oil recovery. For example, a vessel filled with a carbon based ore can be placed at or near the oil well and the carbon based ore can be heated as described herein to generate carbon dioxide. The carbon dioxide can then be injected into the nearby oil well for enhanced oil recovery. In certain examples, the carbon dioxide can be transported to the oil well through a pipeline leading to the oil well from the separator, where the carbon dioxide is separated from the effluent stream from heating the rubblized carbon based ore. The pipeline can be made of a material that is resistant to corrosion. In some cases, the carbon dioxide stream may include a small amount of water, and the mixture of carbon dioxide and water can form carbonic acid. The carbonic acid can corrode some metals such as steel. However, stainless steel can be resistant to this corrosion. In certain examples, a stainless steel pipeline can be used to transport the carbon dioxide from the separator to the oil well. In further examples, the pipeline can be routed to one oil well where a carbon dioxide injection stage of enhanced oil recovery is to be performed. After the enhanced oil recovery stage has been completed, the pipeline can be re-routed to another oil well and carbon dioxide can be injected into that oil well. This can be repeated for multiple oil wells that are near the location of the vessel of rubblized carbon based ore where the carbon dioxide production method described herein is performed.

Enhanced oil recovery is one potential reason for injecting carbon dioxide into a geological formation. In other examples, the carbon dioxide can be injected into a geological formation in order to sequester the carbon dioxide in the geological formation. In certain examples, the carbon dioxide can be injected into a geological formation for supplementing enhanced oil recovery, and a portion of the injected carbon dioxide can be produced together with hydrocarbons at the surface. This carbon dioxide can be collected, separated from the produced hydrocarbons, and then reused for another stage of enhanced oil recovery or sequestered in the geological formation if the enhanced oil recovery process has been completed.

Another potential use for carbon dioxide is injecting the carbon dioxide into a greenhouse to enhance plant growth. Increasing the carbon dioxide concentration inside a greenhouse can speed the growth of crops in the greenhouse as well as enhance their health and quality. Additionally, increasing the carbon dioxide concentration in a greenhouse to a sufficiently high level, at least temporarily, can kill off pests that might be present inside the greenhouse. Carbon dioxide produced using the methods described herein can be transported directly to a greenhouse using a pipeline as described above. Alternatively, the carbon dioxide can be packaged, such as in a pressurized tank, and transported to a greenhouse in that form.

The carbon dioxide produced by the methods described herein can also be used in the food industry. Some uses of carbon dioxide include carbonation of beverages, drying and preservation of fruits and vegetables, dry ice for refrigeration, cryogenic freezing, as a solvent such as for decaffeinating coffee, and others. Many of these utilize carbon dioxide in a supercritical state. Therefore, in some examples the methods described herein can include forming supercritical carbon dioxide for use in processing food or other biological materials. Carbon dioxide can also be used as a solvent to selectively extract hydrocarbons from carbon based ore. The carbon dioxide can be injected into the same body of carbon based ore that was heated to produce the carbon dioxide, or the carbon dioxide can be injected into another body of rubblized carbon based ore. In certain examples, the method can include heating a first body of rubblized carbon based ore in a first vessel and producing carbon dioxide as described above. The carbon dioxide can then be injected into a second vessel that contains a second body of rubblized carbon based ore. The carbon dioxide can be in a supercritical state in some examples. The carbon dioxide can act as a solvent to remove at least a portion of hydrocarbons from the second body of rubblized carbon based ore. The removed hydrocarbons can flow out of the second body of rubblized carbon based ore together with the carbon dioxide to be collected.

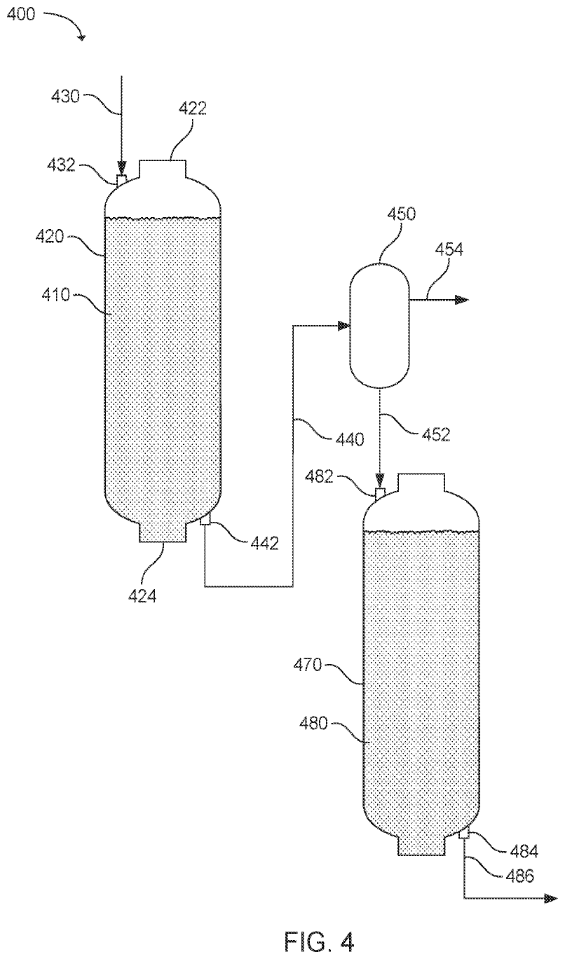

FIG. 4 shows an example system 400 that can be used to generate carbon dioxide and use the carbon dioxide as a solvent. This system includes a first body of rubblized carbon based ore 410 inside a first vessel 420. The first vessel includes an ore inlet 422 and an ore outlet 424. A working fluid stream 430 flows into the first vessel through a working fluid inlet 432. As explained above, the working fluid can include a less than stoichiometric amount of oxygen. The rubblized carbon based ore in the first vessel can be heated by heat transferred from the working fluid and/or heat generated by combustion within the first body of rubblized carbon based ore. The effluent stream 440 from the first vessel can include carbon dioxide, water vapor, and optionally hydrocarbons. The effluent stream flows out of the first vessel through a fluid outlet 442. The effluent stream flows to a separator 450 that separates the carbon dioxide from the other components of the effluent stream. A carbon dioxide stream 452 and a residual stream 454 flow out of the separator. The carbon dioxide stream flows into a second vessel 470 through a carbon dioxide inlet 482. The second vessel contains a second body of rubblized carbon based ore 480. This ore contains hydrocarbons that can be removed by carbon dioxide acting as a solvent. In some cases, the carbon dioxide can be compressed to a supercritical state before being injected into the second vessel. A mixture of carbon dioxide and hydrocarbons can flow out a product outlet 484 as a product stream 486. In certain examples, the ore in the second body of rubblized carbon based ore can be ore that has already undergone a heating process to produce hydrocarbons therefrom, and the carbon dioxide can be injected to recover additional hydrocarbons. In other examples, the ore in the second body of rubblized carbon based ore can be subjected to a heating process after the carbon dioxide has been injected to remove the hydrocarbons, and the heating process can generate additional carbon dioxide as a product.

Some types of carbon based ore can contain bitumen. The bitumen can be extracted by injecting supercritical carbon dioxide into the ore. Therefore, in certain examples the carbon dioxide produced by the methods described herein can be injected as supercritical carbon dioxide into such a carbon based ore to remove bitumen. For example, supercritical carbon dioxide can be injected into a vessel containing the ore. After flowing supercritical carbon dioxide through the vessel for a sufficient time to remove the bitumen, the pressure in the vessel can be reduced so that the supercritical carbon dioxide is converted to a gas and leaves the ore. In some cases, this can leave behind a porous residual ore, where the ore includes empty pores that had originally been filled with bitumen. Some types of ore can also contain other valuable minerals that may be difficult to access when the bitumen is present. However, after removing the bitumen, some minerals can be exposed and the minerals can be recovered by dissolving with an appropriate solvent or leaching. In a particular example, the residual porous ore can contain barium carbonates and rare earth elements. The methods described above can also include injecting sulfuric acid into this residual ore to dissolve the barium carbonates and rare earth elements and recovering one or more of these materials.

It is noted that the examples shown in the figures include vessels that are oriented vertically. However, the methods described herein can be performed with vessels having any orientation, such as vertical, horizontal, or inclined. Additionally, the direction of flow of gases through the vessels is depicted as being in a top-down direction in the examples shown in figures. However, the methods described herein can also be performed with a different direction of flow. In some examples, gases can flow from the bottoms of the vessels toward the tops of the vessels. In other examples, gases can flow from one side to another, such as in horizontal vessels. If inclined vessels are used, gases can flow from an upper end of the vessel to a lower end or from a lower end to an upper end. Liquids can flow in a downward direction under the force of gravity. Therefore, it can be useful to have a liquid outlet at or near a bottom of the vessels. In certain examples, it can also be useful to have the direction of gas flow in a top-down direction because this can result in cooler regions of the carbon ore being lower in the vessel, and condensed liquids can flow downward under the force of gravity through the cooler regions without being re-vaporized.

For purposes of clarity, the following clauses enunciate specific variations and combinations that are expressly contemplated by the disclosure.
Clause 1. A method of producing commercially pure carbon dioxide, comprising:
   a) providing a body of rubblized carbon based ore;
   b) heating the body of rubblized carbon based ore at an elevated temperature under an oxygen deficient atmosphere to produce water, carbon dioxide, a residual mineral ore, and optionally hydrocarbon products; and
   c) separating the carbon dioxide from the water and optional hydrocarbon products.
Clause 2. The method of any clause, wherein the oxygen deficient atmosphere is free of nitrogen.
Clause 3. The method of any clause, wherein the oxygen deficient atmosphere comprises a hydrocarbon heat carrier gas and oxygen having an oxygen concentration less than 10% by volume.
Clause 4. The method of any clause, wherein the oxygen concentration is less than 5% by volume.
Clause 5. The method of any clause, wherein the rubblized carbon based ore is a raw ore.
Clause 6. The method of any clause, wherein the heating includes decomposing of carbonates in the rubblized carbon based ore, performed simultaneously with a low temperature pyrolysis process in which the carbon based ore is pyrolyzed via an oxygen limited pyrolysis process to produce a hydrocarbon product and a spent ore.
Clause 7. The method of any clause, wherein the elevated temperature is from 600° F. to 950° F.
Clause 8. The method of any clause, wherein the rubblized carbon based ore is a spent ore obtained through a low temperature pyrolysis process in which the carbon based ore is pyrolyzed via an oxygen limited pyrolysis process to produce a hydrocarbon product and the spent ore.
Clause 9. The method of any clause, wherein the heating is performed on the spent ore to decompose carbonates in the spent ore at an elevated decomposition temperature.
Clause 10. The method of any clause, wherein the elevated decomposition temperature is from 950° F. to 1500° F.
Clause 11. The method of any clause, wherein the rubblized carbon based ore is a spent ore obtained through a low temperature pyrolysis process in which the carbon based ore is pyrolyzed via a low temperature process to produce a hydrocarbon product and the spent ore.
Clause 12. The method of any clause, wherein the carbon based ore comprises at least one of oil shale, coal, tar sands, peat, and tazmanite.
Clause 13. The method of any clause, wherein the carbon based ore is coal.
Clause 14. The method of any clause, wherein the carbon based ore comprises Green River oil shale from the Mahogany marker.
Clause 15. The method of any clause, wherein the separating includes:
   a) condensing water and condensable hydrocarbons to form a liquid water and a liquid hydrocarbon;
   b) separating non-condensable hydrocarbons from the carbon dioxide; and
   c) recycling the non-condensable hydrocarbons as a heat carrier gas and a fuel gas.
Clause 16. The method of any clause, further comprising injecting the carbon dioxide into an oil reservoir to supplement an enhanced oil recovery process.
Clause 17. The method of any clause, wherein the carbon dioxide is transported from a carbon dioxide production location to the oil reservoir via a stationary stainless steel pipeline.
Clause 18. The method of any clause, further comprising introducing the carbon dioxide into a greenhouse to enhance plant growth.
Clause 19. The method of any clause, wherein the elevated temperature is below a stoichiometric combustion temperature and is controlled by maintaining oxygen concentrations below stoichiometric ratios.
Clause 20. The method of any clause, wherein the oxygen concentrations are maintained by varying at least one of inlet oxygen concentrations and inlet oxygen mass flow rates.
Clause 21. The method of any clause, further comprising injecting the carbon dioxide into a geological formation for sequestering.
Clause 22. The method of any clause, further comprising injecting the carbon dioxide into a geological formation for enhanced oil recovery.
Clause 23. The method of any clause, further comprising forming a supercritical CO₂ of the carbon dioxide for processing of food or other biological materials.
Clause 24. The method of any clause, further comprising injecting the carbon dioxide into a second body of carbon based ore as a solvent to selectively extract hydrocarbons from the second body of carbon based ore.
Clause 25. The method of any clause, wherein the second body of carbon based ore includes bitumen which is extracted when the carbon dioxide is injected as supercritical CO₂ and the method further comprises:
   a) removing the bitumen and supercritical CO₂ to leave a porous ore; and
   b) injecting sulfuric acid into the porous ore to dissolve barium carbonates with rare earth elements.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method of producing commercially pure carbon dioxide, comprising:
a) providing a body of rubblized carbon based ore;
b) heating the body of rubblized carbon based ore at an elevated temperature under an oxygen deficient atmosphere to produce water, carbon dioxide, a residual mineral ore, and optionally hydrocarbon products; and
c) separating the carbon dioxide from the water and optional hydrocarbon products.

2. The method of claim 1, wherein the oxygen deficient atmosphere is free of nitrogen.

3. The method of claim 1, wherein the oxygen deficient atmosphere comprises a hydrocarbon heat carrier gas and oxygen having an oxygen concentration less than 10% by volume.

4. The method of claim 3, wherein the oxygen concentration is less than 5% by volume.

5. The method of claim 1, wherein the rubblized carbon based ore is a raw ore.

6. The method of claim 5, wherein the heating includes decomposing of carbonates in the rubblized carbon based ore, performed simultaneously with a low temperature pyrolysis process in which the carbon based ore is pyrolyzed via an oxygen limited pyrolysis process to produce a hydrocarbon product and a spent ore.

7. The method of claim 5, wherein the elevated temperature is from 600° F. to 950° F.

8. The method of claim 1, wherein the rubblized carbon based ore is a spent ore obtained through a low temperature pyrolysis process in which the carbon based ore is pyrolyzed via an oxygen limited pyrolysis process to produce a hydrocarbon product and the spent ore.

9. The method of claim 8, wherein the heating is performed on the spent ore to decompose carbonates in the spent ore at an elevated decomposition temperature.

10. The method of claim 9, wherein the elevated decomposition temperature is from 950° F. to 1500° F.

11. The method of claim 1, wherein the rubblized carbon based ore is a spent ore obtained through a low temperature pyrolysis process in which the carbon based ore is pyrolyzed via a low temperature process to produce a hydrocarbon product and the spent ore.

12. The method of claim 1, wherein the carbon based ore comprises at least one of oil shale, coal, tar sands, peat, and tazmanite.

13. The method of claim 1, wherein the carbon based ore is coal.

14. The method of claim 1, wherein the carbon based ore comprises Green River oil shale from the Mahogany marker.

15. The method of claim 1, wherein the separating includes:
a) condensing water and condensable hydrocarbons to form a liquid water and a liquid hydrocarbon;
b) separating non-condensable hydrocarbons from the carbon dioxide; and
c) recycling the non-condensable hydrocarbons as a heat carrier gas and a fuel gas.

16. The method of claim 1, further comprising injecting the carbon dioxide into an oil reservoir to supplement an enhanced oil recovery process.

17. The method of claim 16, wherein the carbon dioxide is transported from a carbon dioxide production location to the oil reservoir via a stationary stainless steel pipeline.

18. The method of claim 1, further comprising introducing the carbon dioxide into a greenhouse to enhance plant growth.

19. The method of claim 1, wherein the elevated temperature is below a stoichiometric combustion temperature and is controlled by maintaining oxygen concentrations below stoichiometric ratios.

20. The method of claim 19, wherein the oxygen concentrations are maintained by varying at least one of inlet oxygen concentrations and inlet oxygen mass flow rates.

21. The method of claim 1, further comprising injecting the carbon dioxide into a geological formation for sequestering.

22. The method of claim 1, further comprising injecting the carbon dioxide into a geological formation for enhanced oil recovery.

23. The method of claim 1, further comprising forming a supercritical CO₂ of the carbon dioxide for processing of food or other biological materials.

24. The method of claim 1, further comprising injecting the carbon dioxide into a second body of carbon based ore as a solvent to selectively extract hydrocarbons from the second body of carbon based ore.

25. The method of claim 24, wherein the second body of carbon based ore includes bitumen which is extracted when the carbon dioxide is injected as supercritical CO₂ and the method further comprises:
a) removing the bitumen and supercritical CO₂ to leave a porous ore; and
b) injecting sulfuric acid into the porous ore to dissolve barium carbonates with rare earth elements.
